(19) United States
(12) Patent Application Publication
(10) Pub. No.: US 2026/0105780 A1
(43) Pub. Date: Apr. 16, 2026

(54) SYSTEM AND METHOD FOR MULTI-PHASED 3D GESTURE SYNTHESIS

(71) Applicant: Samsung Electronics Co., Ltd., Gyeonggi-do (KR)

(72) Inventors: Menghe ZHANG, San Diego, CA (US); Yangwen LIANG, San Diego, CA (US); Shuangquan WANG, San Diego, CA (US); Kee-Bong SONG, San Diego, CA (US)

(21) Appl. No.: 19/345,402

(22) Filed: Sep. 30, 2025

Related U.S. Application Data
(60) Provisional application No. 63/707,422, filed on Oct. 15, 2024.

(51) Int. Cl. G06V 40/20; G06V 10/764; G06V 10/82

(52) U.S. Cl. CPC G06V 40/28; G06V 10/764; G06V 10/82

(57) ABSTRACT

A system and a method are disclosed for multi-phased 3D gesture synthesis. A method may include receiving, by a neural network, input data including sequence labels and phase labels, where the sequence labels represent gestures and the phase labels include a phase label for each sequence frame within the gestures; encoding, by the neural network, the input data to create embeddings of the data that are represented in a latent space; decoding, by the neural network, the embeddings of the data that are represented in the latent space; and translating the decoded embeddings into to gesture sequences corresponding to a specified gesture classification.

### CROSS-REFERENCE TO RELATED APPLICATION

This application claims the priority benefit under 35 U.S.C. § 119(e) of U.S. Provisional Application No. 63/707,422, filed on Oct. 15, 2024, the disclosure of which is incorporated by reference in its entirety as if fully set forth herein.

### TECHNICAL FIELD

The disclosure generally relates to 3-dimensional (3D) gesture recognition. More particularly, the subject matter disclosed herein relates to a transformer-based conditional variational autoencoder (CVAE) framework for synthesizing multi-phased 3D gesture sequences for gesture recognition.

### SUMMARY

Barehand 3D interactions represent an intuitive method for humans to engage with technology. Within this domain, various tasks may include 3D hand pose estimation (HPE) and hand gesture recognition (HGR), where the variation and accuracy of hand gestures may be pivotal for enhancing performance. However, acquiring hand gestures with natural motion may pose significant challenges, including complex setups and precise annotations of hand joints and mesh.

Some approaches to hand motion synthesis encounter various challenges, such as synthesizing physically realistic and controllable semantic input, e.g., hand gesture sequences, and providing unified annotations of hand joints and fitted hand meshes to allow for the generation of dynamic sequences for HPE.

Additionally, gesture datasets typically adopt a binary approach (i.e., gesture/non-gesture), which do not reflect that some gestures may consist of different phases (such as peak phases, transition phases, and neutral phases), which may include one or more frames.

FIG. 1 illustrates an example of a “Good Luck” gesture sequence split into three phases.

Referring to FIG. 1, the “Good Luck” gesture sequence, i.e., crossing the middle and point fingers on one hand, may be split into a peak phase 101, a transition phase 102, and a neutral phase 103. In the example of FIG. 1, the peak phase 101 includes four frames 101a, 101b, 101c, and 101d, the transition phase 102 includes four frames 102a, 102b, 102c, and 102d, and the neutral phase 103 includes three frames 103a, a03b, and 103c. The peak phase 101 indicates a hand gesture in “peak”, i.e., a target hand pose, the neutral phase 103 indicates an open palm pose, and the transition phase 102 includes frames transitioning from the peak phase to the neutral phase or from the neutral phase to the peak phase.

For gesture recognition tasks, a gesture sequence may include these types of sequential gestural phases. However, existing datasets, including real and synthetic ones, lack such annotations for each frame of a phase.

Research has highlighted the importance of incorporating the time domain as an additional dimension to improve HPE and HGR. However, some methods lack a unified approach to synthetic hand gesture generation that integrates both static and dynamic aspects, along with annotations for both HPE and HGR. Additionally, some synthetic hand datasets lack semantic meaningful gestures, physical constraints, motion dynamism, and are subject and environmental variance.

Further, real-world data with 3D annotations can be costly, as it may require significant resources for capture and accurate labeling.

These types of challenges emphasize a need for techniques capable of synthesizing multi-phased 3D hand gestures with high fidelity and variability.

Most hand gesture synthesis primarily focuses on co-speech gestures and interactions with hand-held objects. These works may employ convolutional neural networks (CNNs) and long short-term memory networks (LSTMs) for end-to-end modeling. While recent advancements have explored the use of VAEs and generative adversarial networks (GANs), they do not categorize motions by specific gestures or for distinct purposes. In short, there is a notable absence of models designed for generating static and dynamic gestures conditioned on gesture categories. For example, existing synthetic hand datasets lack semantic meaningful gestures, physical constraints, motion dynamism, subject variance, and environmental variance.

Accordingly, an aspect of this disclosure is to provide a transformer-based conditioned VAE framework for synthesizing multi-phased 3D hand gesture sequences. Designed to generate synthetic hand gestures based on predefined gesture categories (i.e., labels), the transformer-based CVAE framework may provide materials for enhancing training and performance of HPE and HGR systems.

Another aspect of this disclosure is to enhance a synthesis process with multi-phase annotations for gesture sequences.

Another aspect of this disclosure is to create anatomically accurate hand meshes and 3D joints using biomechanical constraints for each sequence frame.

In accordance with an aspect of the disclosure, a method for synthesizing multi-level labeled gesture sequences is provided, which may include generating sequence-level labels, i.e., generating hand motions based on predefined gesture category labels, and generating frame-level labels, i.e., annotating each sequence frame with phase labels to detail the gestures.

In accordance with another aspect of the disclosure, biomechanical constraints may be provided to ensure life-like human hand motions. More specifically, biomechanical constraints may be applied as loss functions and/or as a physical projection layer.

Further, critical constraints may be provided, such as intra-/inter-finger constraints and collision guided anti-penetration.

In an embodiment, a method of generating gesture sequences is provided. The method includes receiving, by a neural network, input data including sequence labels and phase labels, where the sequence labels represent gestures and the phase labels include a phase label for each sequence frame within the gestures; encoding, by the neural network, the input data to create embeddings of the data that are represented in a latent space; decoding, by the neural network, the embeddings of the data that are represented in the latent space; and translating the decoded embeddings into to gesture sequences corresponding to a specified gesture classification.

In an embodiment, a system for generating gesture sequences is provided. The system includes a neural network; a processor; and a memory for storing instructions, which when executed by the processor, control the processor to control the neural network to receive input data including sequence labels and phase labels, where the sequence labels represent gestures and the phase labels include a phase label for each sequence frame within the gestures, control the neural network to encode the input data to create embeddings of the data that are represented in a latent space, control the neural network to decode the embeddings of the data that are represented in the latent space, and translate the decoded embeddings into to gesture sequences corresponding to a specified gesture classification.

### BRIEF DESCRIPTION OF THE DRAWING

In the following section, the aspects of the subject matter disclosed herein will be described with reference to exemplary embodiments illustrated in the figures, in which:

FIG. 1 illustrates an example of a “Good Luck” gesture sequence split into three phases;

FIG. 2 illustrates a high-level example of CVAE gesture synthesis, according to an embodiment;

FIG. 3 illustrates operation of a transformer-based CVAE for multi-phased gesture synthesis, according to an embodiment;

FIG. 4 illustrates an example of skeleton drawings of sequences generated using transformer-based CVAE for multi-phased gesture synthesis, according to an embodiment;

FIG. 5 illustrates an example of hand kinematics defining joint rotation ranges for joints on three axes, according to an embodiment;

FIG. 6 illustrates an example of contact over specific skin mesh, according to an embodiment;

FIG. 7 illustrates an example of self-collision, according to an embodiment;

FIG. 8 illustrates an example of a comparison of raw poses with various constraint levels according to an embodiment;

FIG. 9 illustrates collision guided anti-penetration, according to an embodiment;

FIG. 10 is a flowchart illustrating a method, according to an embodiment; and

FIG. 11 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Motion sequence” as used herein may refer to a temporally ordered series of poses or configurations representing the movement of an object, body part, or structure over time. A motion sequence may correspond to hand motion, facial motion, full-body motion, robotic articulation, or any other deformable or rigid-body movement captured or synthesized across multiple frames. Some examples of “motion sequence” are a sequence of 3D hand poses during a gesture, a series of joint angles in a robotic arm trajectory, or a body movement animation captured using pose parameters.

“Motion dynamism” as used herein may refer to the use of movement, trajectory, and articulation of body parts over time to identify and classify gestures, as opposed to static gestures which rely only on a single pose. For example, methods for analyzing motion dynamism may include extracting finger and global motion features to classify complex dynamic gestures in various applications such as human-computer interaction (HCI) and robotics.

“Semantic input” as used herein may refer to an input signal that conveys intent or instruction that guides the generation or modification of a motion sequence or image content. A semantic input may be provided in natural language, structured text, labeled gesture categories, visual demonstrations, or other symbolic or descriptive formats. Some examples of “semantic input” are a text prompt such as “pinch,” a demonstration image or a short clip of a hand pose, or an action label such as “wave left.”

“Tokenization” as used herein may refer to preparing input data and its associated conditions into numerical, fixed-size representations that a model can process. The specific method may depend on a data type (e.g., text, image, molecular data) and the conditional information being used.

“Reparameterization” as used herein may refer to the “reparameterization trick”, a technique that allows a model to be trained end-to-end using gradient descent. Reparameterization works by reformulating a sampling of latent variables from a distribution (e.g., a Gaussian distribution) into a deterministic function of the model's parameters and a standard random variable. This moves random sampling outside a network, allowing gradients to flow from a decoder back to an encoder for learning structured latent representations.

A “tensor” as used herein may refer to a multidimensional array of numbers, serving as a data structure to hold input data, parameters, and model outputs. The term tensor may be used to generalize concepts like scalars (0-dimensional tensors), vectors (1-dimensional tensors), and matrices (2-dimensional tensors) into N-dimensional arrays. Tensors may be used to represent complex data like images, text, and video, and their optimized structure allows for efficient processing.

“HPE” as used herein may refer to a computer vision and robotics technology that identifies and reconstructs a 3D skeleton or mesh model of a hand from visual or sensor data, enabling applications like gesture control in augmented reality (AR)/virtual reality (VR), sign language recognition, and robotics. For example, multi-view videos and sensor networks within gloves may be used to improve accuracy and robustness against issues like occlusion. Techniques herein may include using deep learning models like transformers and graph neural networks (GNNs) to process sequential and spatial information from images or sensor data to predict hand joint positions.

“HGR” as used herein may refer to a process of using computers to understand and interpret human hand movements and postures, facilitating natural HCJ. Systems may capture and analyze hand data using various sensors, such as cameras, to detect static and dynamic gestures, which may then be classified by machine learning (ML) models. HGR may be utilized in various applications, such as for accessibility for people with disabilities, smart device control, VR, AR, and sign language translation.

A “hand mesh” as used herein may refer to a 3D surface representation of the human hand, usually modeled as a polygonal mesh made of vertices (e.g., 3D points), edges (e.g., connections between vertices), and faces (e.g., surface elements, which may be triangles).

HPE with a mesh may refer to an advanced computer vision technique that reconstructs a hand's 3D surface model, including its joints and vertices, from image data. This method may provide a more detailed and accurate representation than traditional skeleton-based HPE, which generally estimates only the positions of key joints.

An HGR with a mesh may refer to a flexible, sensor-filled fabric or surface that can detect and interpret hand movements and gestures, often using a grid of capacitive sensors to sense proximity and capacitance changes as a hand moves near or interacts with it. This technology may be used to create HCIs and other applications, providing a way to control devices and systems through a natural, non-contact interaction.

A variational autoencoder (VAE) may refer to a type of generative model that uses a neural network to learn a compressed, probabilistic representation of data. Unlike a traditional autoencoder, which learns a fixed-point representation, a VAE may encode data into a continuous probability distribution, e.g., a Gaussian, in latent space. This type of probabilistic approach may allow the model to generate new, unique data points that are similar to the original training data.

A CVAE may refer to an extension of the VAE that allows a generative model to be controlled by auxiliary information, such as class labels. This “conditioning” allows for the generation of data with specific characteristics, addressing a VAE's limitation of having no direct control over its output. While a VAE learns to compress data into a smooth, continuous latent space and then reconstruct it from a sample of that space, a CVAE extends this by conditioning both an encoder and a decoder on additional information. For example, a “condition” can be a label, an image, or some other context, allowing for more specific and controlled generation.

A transformer-based CVAE may refer to a generative model that combines probabilistic generative abilities of a CVAE with a sequence-modeling power of a transformer architecture. This type of hybrid model may be effective for generating diverse and coherent sequences, such as gestures, text, music, and story plots, by leveraging a self-attention mechanism to capture long-range dependencies.

“Synthesis” or “synthesizing” as used herein may refer to a process of generating novel data instances that align with a specified set of conditions. For example, data synthesis or generation is a functionality that differentiates a CVAE (Conditional Variational Autoencoder) from a simple VAE (Variational Autoencoder), which randomly generates new data.

A “sequence label,” “action label,” or “gesture label” as used herein may refer to a class identifier assigned to an entire gesture sequence, indicating an overall gesture type (e.g., “wave” or “point”).

A “phase label” as used herein may refer to a class identifier assigned to individual frames within the sequence, indicating a temporal phase or sub-action associated with the frame.

As described above, according to an embodiment, a transformer-based CVAE framework is provided herein for synthesizing multi-phased 3D hand gesture sequences. More specifically, transformer-based CVAE framework may generate synthetic hand gestures based on predefined gesture categories, and may be used to enhance training and performance of HPE and HGR systems. That is, a transformer-based architecture with positional encoding may be used to capture inter-frame dependencies within gesture sequences, and conditioning the VAE on hand articulations with biomechanical constraints may allow for close simulations of natural hand motions. These approaches together may facilitate conditioned-sequence-level embeddings for realistic and smooth hand gestures.

Accordingly, various embodiments of the disclosure may be used to address challenges of synthesizing controllable and anatomically correct multi-phased 3D hand gestures, which is applicable across various domains requiring realistic hand interaction simulations.

Although various embodiments of the present disclosure are described below with an emphasis on 3D HPE and HGR, the present disclosure is not limited thereto. For example, embodiments of the disclosure may also be applicable to gesture recognition based on full body motion sequences or sequences involving other body parts than the hands.

An autoencoders may be a self-supervised system with a training goal to compress (or encode) input data through dimensionality reduction and then reconstruct (or decode) the original input by using the compressed representation. While different types of autoencoders may add or alter certain aspects of their architecture to better suit specific goals and data types, generally, an autoencoder includes an encoder, a bottleneck (or code), and a decoder.

The encoder extracts latent variables of input data x and outputs them in the form of a vector representing latent space z. In an autoencoder, each subsequent layer of the encoder contains progressively fewer nodes than the previous layer. That is, as data traverses each encoder layer, it may be compressed into fewer dimensions.

Other autoencoder variants may use regularization terms, like a function that enforces sparsity by penalizing the number of nodes that are activated at each layer, to achieve dimensionality reduction.

The bottleneck, or code, which includes the latent space, may be both an output layer of the encoder and an input layer of the decoder. The latent space may be a compressed, lower-dimensional embedding of the input data. A sufficient bottleneck may help ensure that the decoder cannot simply copy or memorize the input data, which would prevent the autoencoder from learning.

The decoder may use the latent representations to reconstruct the original input by essentially reversing the encoder. For example, in the decoder architecture, each subsequent layer may contain a progressively larger number of active nodes.

In some autoencoder applications, the decoder aids in the optimization of the encoder and is then discarded after training. However, in VAEs, the decoder is retained and used to generate new data points.

A possible shortcoming of VAEs is that a user has no control over the specific outputs generated by the autoencoder.

To address this type of shortcoming, a CVAE may be used to provide outputs conditioned by specific inputs, rather than solely generating variations of training data at random. For example, this may be achieved by incorporating elements of supervised learning (or semi-supervised learning) alongside the traditionally unsupervised training objectives of autoencoders.

By further training a model on labeled examples of specific variables, the variables can be used to condition the output of the decoder. For example, a CVAE can be first trained on a large data set of facial images, and then trained by using supervised learning to learn a latent encoding for “beards” so that it can output new images of bearded faces.

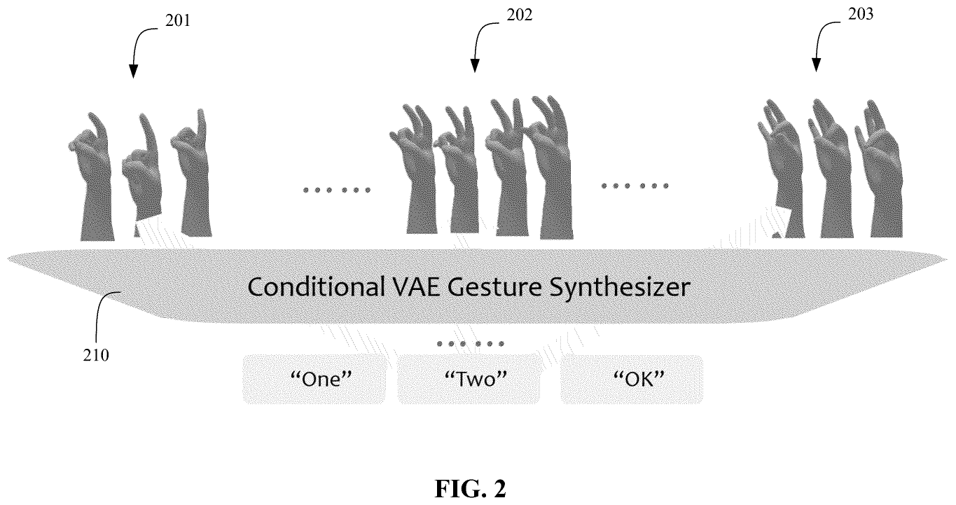

FIG. 2 illustrates a high-level example of CVAE gesture synthesis, according to an embodiment.

Referring to FIG. 2, an operation to synthesize hand gesture sequences with given gesture names is provided. That is, a CVAE gesture synthesizer (e.g., a CVAE trained on a large data set of hand images) 210 may learn to synthesize hand gesture sequences 201, 202, and 203 with given gesture names, e.g., “one”, “two”, “OK”, etc., in the example illustrated in FIG. 2. That is, the CVAE gesture synthesizer 210 may trained by using supervised learning to learn a latent encoding for finger gestures so that it can output new images of hand gesture sequences 201, 202, and 203.

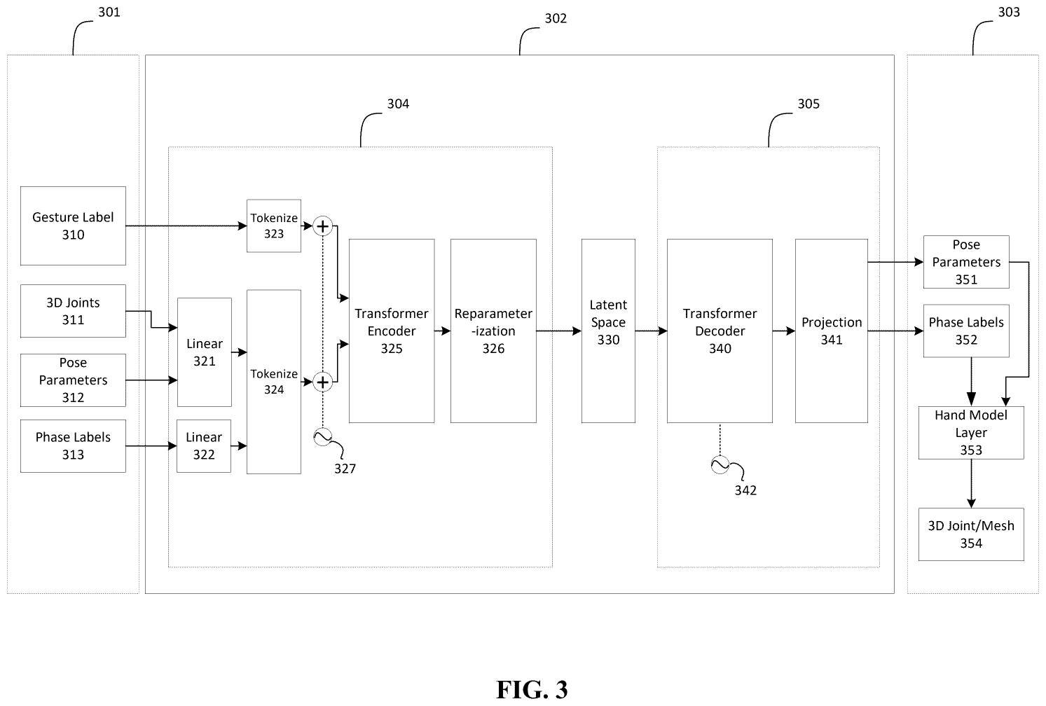

FIG. 3 illustrates operation of a transformer-based CVAE for multi-phased gesture synthesis, according to an embodiment.

More specifically, the architecture of a gesture-conditioned hand motion generation model of FIG. 3 is based on a CVAE framework enhanced with transformer structures in both the encoder and decoder components.

Unlike approaches that focus on generating generic dynamic motion sequences, in accordance with an embodiment of the disclosure, semantic gesture classification and multi-phase annotations may be utilized for both static and dynamic gestures.

Referring to FIG. 3, operation of the transformer-based CVAE for multi-phased gesture synthesis may be generally divided into an input portion 301, a transformer-based CVAE 302, and an output portion 303.

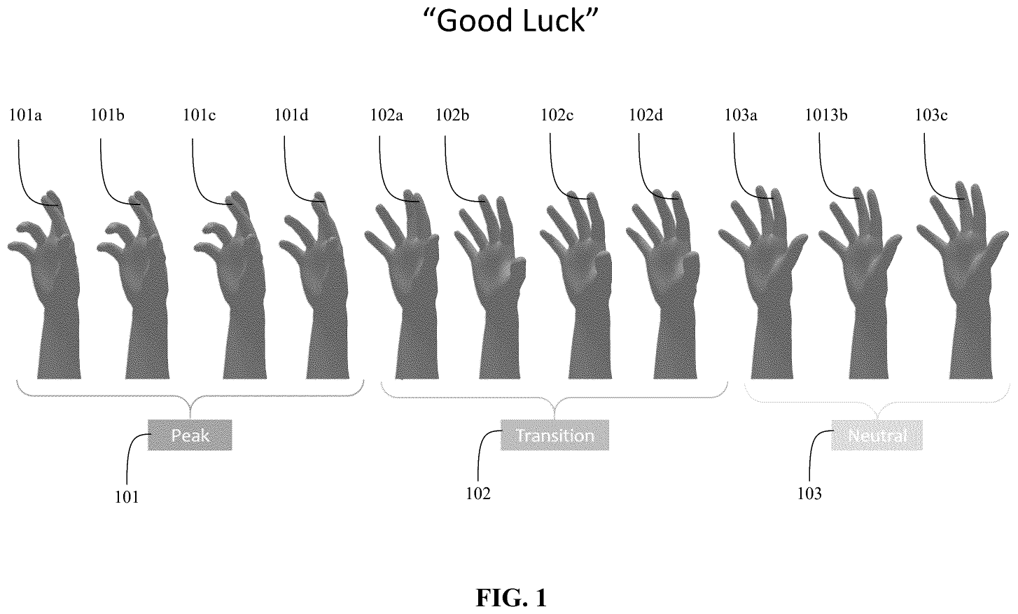

In the example of FIG. 3, the input portion 301 includes gesture (or sequence) labels 310, 3D joints 311, e.g., 3D joint positions of the input hand, pose parameters 312, and phase labels 313 as inputs that are fed to or received by the transformer-based CVAE 302. The gesture label 310 (or sequence label) may represent various gestures such as middle-tip (e.g., touching the tip of the middle finger to the thumb), thumb (e.g., sticking a thumb up), three (e.g. holding up three fingers), ring-tip (e.g., touching the tips of the middle and ring fingers together), OK, five (e.g., holding up five fingers), four (e.g., holding up four fingers), good luck (e.g., crossing the pointer and middle fingers), pinch (e.g., touching the tip of the pointer finger to the thumb), two (e.g., holding up two fingers), pinky-tip (e.g. touching the tip of the pinky to the thumb), fist, one (e.g., holding up one finger), etc. The phase labels 313 (or frame level labels) may annotate each sequence frame with phase labels to detail the gestures. That is, phase labels 313 may include a phase label for each sequence frame within a gesture. For example, the phase labels 313 may include neutral, transition, and peak as illustrated in FIG. 1. The pose parameters 312 may include a sequence of hand poses, e.g., represented by a 16×3 tensor, and the 3D joints 311 may include 3D joint positions, e.g., represented by a 21×3 tensor.

The transformer-based CVAE 302 may include an encoding portion 304, a latent space 330, and a decoding portion 305.

The encoding portion 304, which may be utilized to create sequence-level embedding of poses and phase information, may include a transformer encoder 325, which is a neural network layer that processes input sequences, i.e., the gesture labels 310, 3D joints 311, pose parameters 312, and phase labels 313, to create a continuous representation (or embeddings) of the input, which are represented in the latent space 330. The latent space 330 may be a compressed and continuous representation of the input data, where similar data points are grouped together. However, unlike a standard VAE, the latent space 330 in the transformer-based CVAE 302 may also incorporate conditional information (e.g., the gesture labels 310 and the phase labels 313), allowing it to represent more specific variations within classes rather than general class distinctions. The transformer encoder 325 may map the input and its condition into the latent space 330 as a probability distribution, and the decoding portion 305 may use this conditional latent representation to reconstruct the data. That is, the decoding portion 305 may include a transformer decoder 340 that may use these embeddings in the latent space 330 to generate an output sequence.

More specifically, the encoding portion 304 may receive as input data a sequence of hand poses (e.g., the pose parameters 312), the 3D joint positions (e.g., the 3D joint 311), the frame-level phase labels (e.g., the phase labels 313), and the sequence-level gesture category label (e.g., the gesture labels 310). The input parameters, i.e., the pose parameters 312, the 3D joints 311, and the phase labels 313, are linearly embedded at 321 and 322.

At 323, the gesture label 310 is tokenized, and at 324, the linearly embedded pose parameters 312, 3D joints 311, and phase labels 313 are also tokenized. That is, each input is set to a fixed-size representation that the transformer encoder 325 can process.

At 327, sinusoidal positional encoding may be incorporated to capture temporal dependencies and spatial relationships within a gesture sequence. For example, as transformer based CVAE encoder may have no inherent sense of order, but order may matter in a sequence of hand motions, positional encoding (PE) may be utilized at 327 to inject a temporal position of each frame, e.g., using a sinusoidal function, as shown in Equation (1). Given the embedding dimension dim, maximum sequence length L, for each position index p(0≤p≤L−1) and dimension index i(0≤i≤dim−1), a positional encoding matrix PE∈ [symbol] may be defined as in Equation (1):

[symbol]

$$PE ( p , 2 i ) = sin ( \frac{p}{1000 {0}^{2 i / d i m}} ) , \qquad ( 1 )$$

$$PE ( p , 2 i + 1 ) = cos ( \frac{p}{1000 {0}^{2 i / d i m}} )$$

Thereafter, the encoded representation in the latent space z at position p, zP may be represented as in Equation (2):

$${z}_{p} = Dropout ( {x}_{p} + P E ( p ) ) \qquad ( 2 )$$

As described above, the transformer encoder 325 may encode (process) the input sequences, i.e., the gesture labels 310, 3D joints 311, pose parameters 312, and phase labels 313, to create a continuous representation (or embeddings) of the input, which are represented in the latent space 330. For example, the embeddings of pose and phase information may be concatenated and projected into the latent space 330 that jointly encodes rotational joint sets and phase labels.

At 326, reparameterization may be performed on the output of the transformer encoder 325, prior to projection into the latent space 330. For example, the transformer encoder 325 may map a sequence of poses with some action of label to parameters of Gaussian distribution (μ,σ) in the latent space. To generate a new action sequence, random sampling may be performed in the latent space. However, as direct sampling step is non-differentiable, reparameterization may be utilized to map the (μ,σ) to z, where z=μ+σ*random_noise, and z is the reparametrized (μ,σ) combination.

As described above, the latent space 330 facilitates a sampling space for generation process.

The decoding portion 305, which may be utilized to predict both joint poses and phase labels based on a single latent vector and an action label, may include the transformer decoder 340 that may use these embeddings in the latent space 330 to generate a sequence of vectors from which final poses are derived through linear projection at 341. More specifically, the transformer decoder 340 may generate diverse hand gesture sequences corresponding to a specified gesture classification.

At 342, time information may be introduced through sinusoidal positional encodings (e.g., based on 327) during decoding.

The output portion 303 may include pose parameters 351, phase labels 352, a hand model layer 353, e.g., a differentiable layer that may map low-dimensional parameters into a realistic 3D hand mesh, and 3D joint/mesh 354.

More specifically, the decoding portion 305 outputs the pose parameters 351, e.g., 16×3 tensors, and the phase labels 352 derived through linear projection at 341.

The pose parameters 351 and the phase labels 352 may be provided to the hand model layer 353, e.g., a differentiable MANO hand model layer, which translates the pose parameters 351 and the phase labels 352 in order to generate the 3D joint/mesh 354, e.g., vertices and joints of a synthesized gesture sequence. For example, the synthesized gesture sequences may then be used for display in animation, virtual reality (VR), augmented reality (AR), assistive technologies, or in human-robot interaction to create realistic, context-aware, and expressive non-verbal communication.

By utilizing semantic gesture classification and multi-phase annotations, as described in FIG. 3, temporal and spatial correspondence and variations may be captured together, and utilized for smooth and continuous hand gesture synthesis.

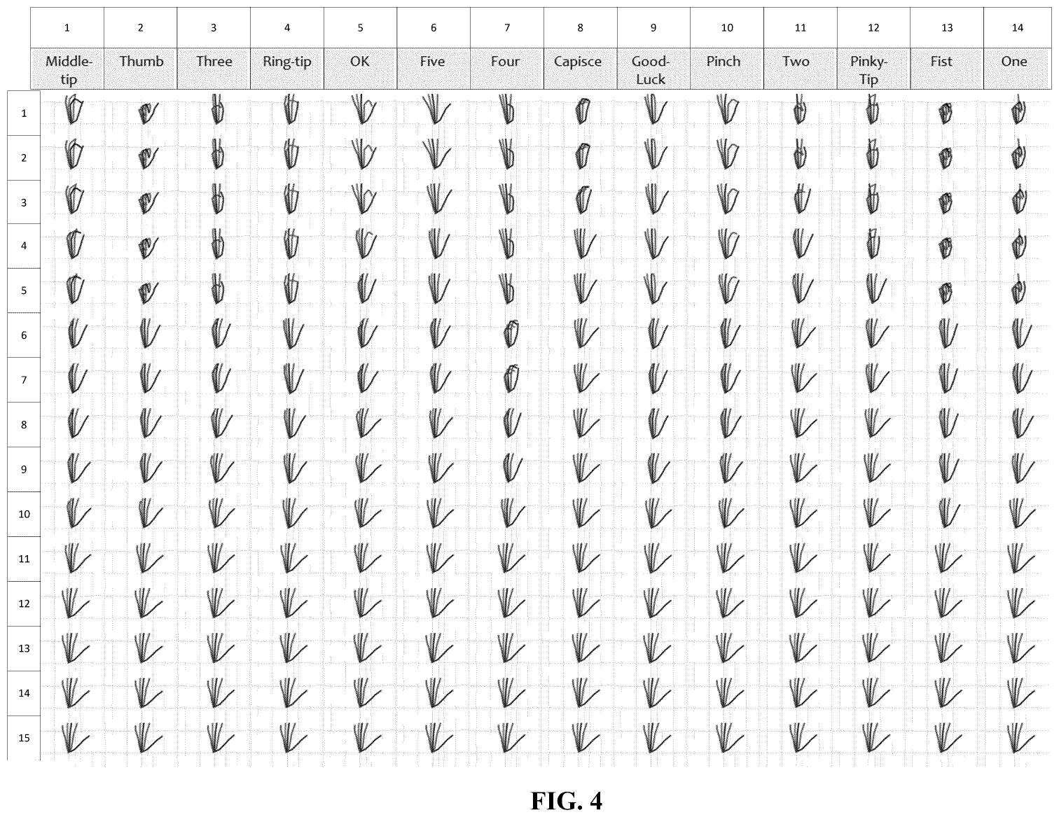

FIG. 4 illustrates an example of skeleton drawings of sequences generated using transformer-based CVAE for multi-phased gesture synthesis, according to an embodiment.

Referring to FIG. 4, 15-frame-gesture sequences are generated from 14 gestures, as illustrated with their skeletal structures. The sequences demonstrate the ability of a model (e.g., as illustrated in FIG. 3) to produce realistic and continuous hand gestures, accurately capturing the nuances of human hand motion.

Based on a transformer-based CVAE operation as illustrated in FIG. 3, multi-phased gesture synthesis may also include biomechanical constraints in loss function, a biomechanical projection layer, as well as hand gesture-specific utilizations.

According to an embodiment, biomechanical constraints as a loss function may be used to maintain natural and realistic hand motions that adhere to human anatomical limits.

More specifically, during a training process of a transformer-based CVAE, e.g., as illustrated in FIG. 3, biomechanical constraints may be provided as complementary to other loss functions, such as Kullback-Leibler (KL) divergence and reconstruction loss of poses and vertices. As a result, the biomechanical constraints may help maintain natural and realistic hand motions that adhere to human anatomical limits. For example, the biomechanical constraints may include a motion angle limitation, attraction, anti-penetration, reconstruction loss, KL loss, and/or phase prediction loss, as will be described below in more detail.

According to an embodiment, biomechanical constraints may be used to provide more realistic human motion dynamics by limiting joint angles to ranges that are physically possible.

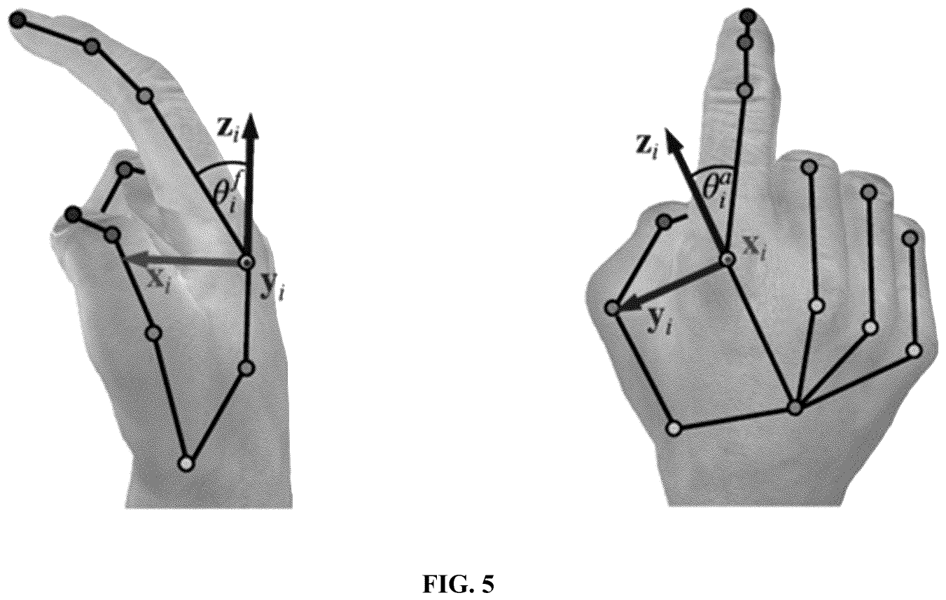

FIG. 5 illustrates an example of hand kinematics defining joint rotation ranges for joints on three axes, according to an embodiment.

Referring to FIG. 5, hand kinematics may define each joint rotation range for 15 joints on three axes X, Y and Z:

$$( {θ}_{i} ∈ [ {θ}_{i}^{f} , {θ}_{i}^{a} ] ,$$

i∈[1,15]).

A convex hull may be approximated on a

$$( {θ}_{i}^{f} , {θ}_{i}^{a} )$$

plane with a fixed set of points Hi, which may be pre-computed from a set of real-world datasets. More specifically, the loss (Lₐ) may be computed as the distance from θᵢ to the convex hull (D_{H}), using Equation (3) below.

$${L}_{a} = \frac{1}{15} {\sum }_{i = 1}^{15} {D}_{H} ( {θ}_{i} , {H}_{i} ) \qquad ( 3 )$$

According to an embodiment, a biomechanical attraction loss may be used to ensure that gestures utilizing tight contact over specific skin areas (i.e., where 2 different skin areas, such as the distal pulp of the index finger and the distal pulp of the thumb, are in contact with each other) are accurately modeled. More specifically, some gestures may require tight contact over specific skin mesh.

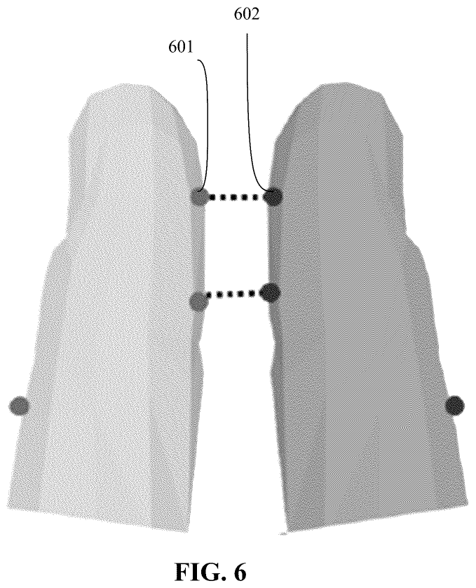

FIG. 6 illustrates an example of contact over specific skin mesh, according to an embodiment.

Referring to FIG. 6, for a pinch gesture, for example, tight contact may be preferred by an index finger and a thumb. If anchors Pᵢ and Pⱼ are closest (e.g., index finger and thumb tips), they may form an anchor pair. That is, the two closet points 601 and 602 may be selected to form an anchor pair. The attraction loss (Lₐₜₜᵣ) within the pair may be computed as using Equation (4) below.

$${L}_{atr} = {\sum }_{i j ∈ A P s} {dist ( {P}_{i} , {P}_{j} )}^{2} \qquad ( 4 )$$

According to an embodiment, biomechanical constraints (e.g., anti-penetration constraints) may prevent self-collision and enhance realism by accurately modeling interactions between different parts of a hand.

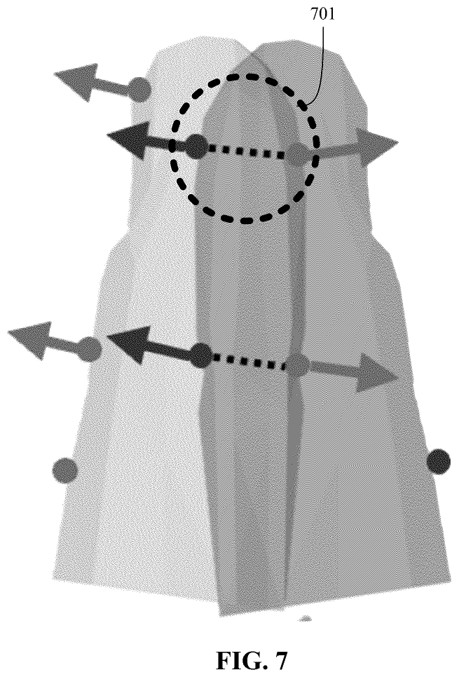

FIG. 7 illustrates an example of self-collision, according to an embodiment.

Referring to FIG. 7, biomechanical constraints may prevent self-collision as illustrated, wherein two fingers are unrealistically, simultaneously occupying a same space 701. For example, biomechanical constraints may prevent fingers from unrealistically passing through each other.

More specifically, to prevent self-collision, given a hand mesh, a conical 3D distance signed distance field (SDF) may be provided to query for its self-intersections. An SDF value may be used to describe how far away points in a 3D space are from a surface of a cone (inside-negative, outside-positive). As SDF value states within a hand are positive and proportional to the distance from the surface, and zero outside, a penetration loss (Lᵢₙₜₑᵣ) may be defined using Equation (5).

$${L}_{inter} = \{ \begin{matrix}0 , & collision rto < threshold \\ {\sum }_{v ∈ V} - min ( SDF ( v ) , 0 ) , & otherwise\end{matrix} \qquad ( 5 )$$

According to an embodiment of the disclosure, other non-biomechanical losses, such reconstruction loss, KL loss, and/or Phase prediction loss may also be used during a training process of a transformer-based CVAE to maintain natural and realistic hand motions that adhere to human anatomical limits.

According to an embodiment, reconstruction loss (Lᵣ) may include pose reconstruction loss (L_{P}) and mesh reconstruction loss (L_{V}), which measures a difference of the reconstructed hand poses and vertices compared to a ground-truth one.

According to an embodiment, utilizing KL loss (L_{KL}), the latent space may be regularized by penalizing divergence between the encoder's posterior distribution and a Gaussian prior. This minimizes KL divergence between the encoder distributions and target distributions.

According to an embodiment, a phase prediction loss (or phase label loss) (L_{PL}) component may be introduced to improve prediction accuracy of phase labels, which enhances a model's ability to generate sequences that reflect realistic phase transitions within gestures. For example, a phase labels loss function may be used to predict phase labels through a generation process.

According to an embedment, when utilizing the different loss functions described above, a final loss function may be a weighted sum of all the components as shown in Equation (6).

$$L = {ω}_{a} {L}_{a} + {ω}_{attr} {L}_{attr} + {ω}_{inter} {L}_{inter} + {ω}_{r} ( {L}_{P} + {L}_{V} ) + {ω}_{K L} {L}_{K L} + {ω}_{P L} {L}_{P L} \qquad ( 6 )$$

In Equation (6), ω represents a weight for each loss.

According to an embodiment, a biomechanical projection layer, e.g., at 341 in FIG. 3, may be provided that projects generated motions to anatomically constrained ones. For example, the biomechanical projection layer may implement intra-finger and inter-finger constraints and collision guided anti-penetration.

### Intra-Finger and Inter-Finger Constraints:

According to an embodiment, unlike models that set motion limits for each joint independently, intra- and inter-finger constraints may be provided through an analysis of kinematic behaviors, which allows a more holistic understanding and realistic simulation of finger interactions. This implementation may allow for more realistic simulations of hand motions, closely mimicking human dexterity and interaction.

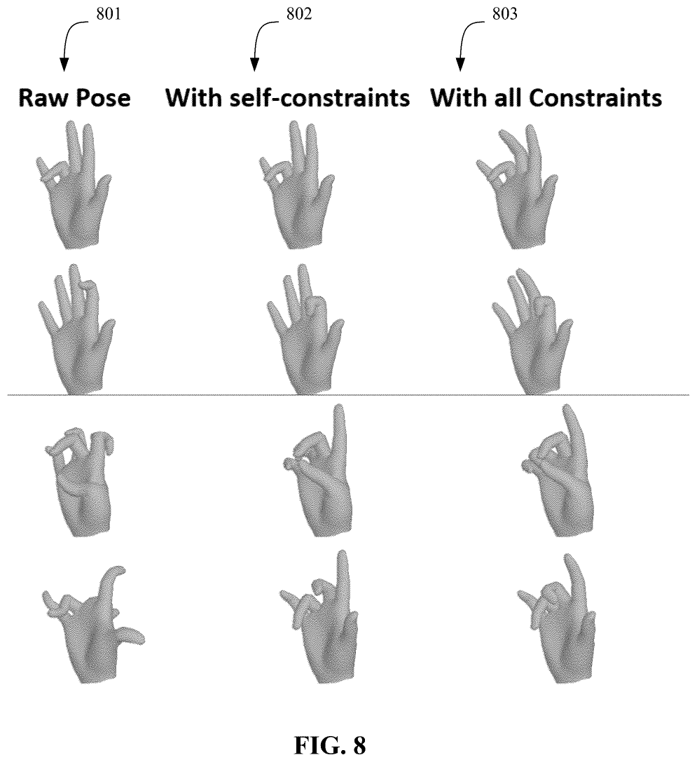

FIG. 8 illustrates an example of a comparison of raw poses with various constraint levels, according to an embodiment.

Referring to 8, raw poses of gestures are provided in column 801. Columns 802 and 803 illustrate the gestures with the application of self-constraints and all constraints, respectively. The self-constraints in column 802 may include single finger anatomical constraints with intra-finger constraints, and the all constraints in column 803 may include self-constraints with inter-finger constraints. For example, the intra-finger constraints may be utilized to establish realistic motion limits for individual finger joints, and the inter-finger constraints may be incorporated into a model by simulating inter-finger coupling effects using a matrix formulation.

As shown in the examples of FIG. 8, the application of self-constraints in column 802 may be used to improve the realism, e.g., create more realistic hand and finger positioning, of the raw poses in 801, while the application of all constraints in column 803 may be used to improve the realism even further.

Beyond the use of SDFs for resolving self-penetration issues, an embodiment of the present disclosure may utilize collision guided anti-penetration. That is, a collision ratio-depth map may be used to iteratively correct self-penetration. This optimization may be performed on an affected group (e.g., a finger), guided by detailed collision data and depth measurements.

Using collision guided anti-penetration, e.g., with initial MANO poses as the input, the following algorithm in Table 1 may be used to iteratively resolve self-penetration by optimizing poses while maintaining a low-rate of pose changes.

```
TABLE 1
BEGIN
  SDF ← ComputeSDF(initial_pose)
  convergence ← FALSE
  WHILE NOT convergence DO
    FOR each finger_group IN hand model DO
      ratio ← CalculatePenetrationRatio(finger_group)
      depth ← CalculatePenetrationDepth(finger_group)
    END FOR
    max_severity_group ← SelectGroupWithMaxSeverity(ratio, depth)
    GradientDescent(minimize(SDF, max_severity_group))
    UpdatePose(hand_model, max_severity_group)
    convergence ← CheckConvergence(hand_model, threshold)
  END WHILE
  RETURN hand model
END
```

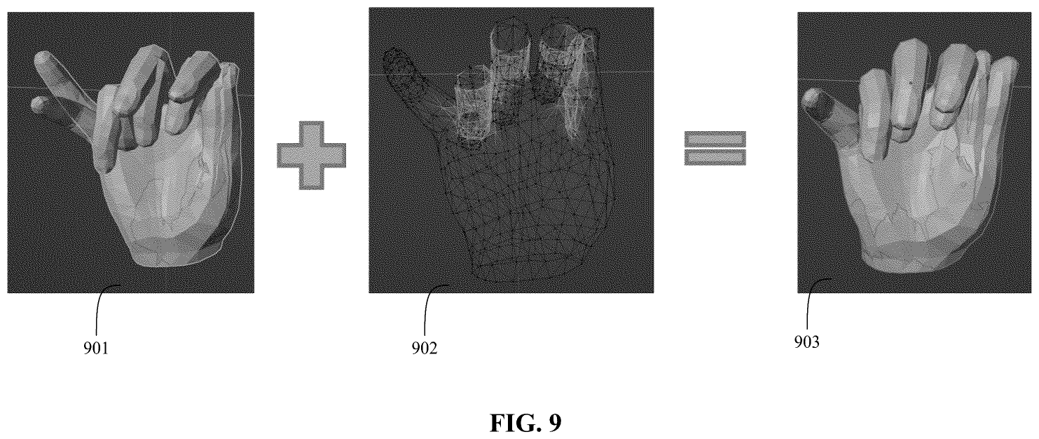

FIG. 9 illustrates collision guided anti-penetration, according to an embodiment. More specifically, FIG. 9 illustrates a comparative analysis of anti-penetration optimization methods.

Referring to FIG. 9, the display on the left 901 provides traditional method before-and-after results. The center display 902 provides a collision map as used herein.

The display on the right 903 provides before-and-after results according to a method in accordance with an embodiment of the disclosure. While both displays 901 and 903 effectively resolve the collision, as illustrated in 903, the method in accordance with an embodiment of the disclosure results in fewer alterations to the original configuration.

While embodiments of the disclosure have been described above with reference to a transformer-based conditional VAE including a transformer-based encoder/decoder, the embodiments may also be applicable to recurrent neural networks (RNNs), such as LSTM networks or gated recurrent units (GRUs).

Also, as the human hand is a high-articulated model with clear graph structure, GNNs may be utilized to model the relationships between different joints.

Additionally, embedding of the phase status can be described as a classification problem, where a one-hot matrix may be created for the labels and the encoder may output a phase class label for each frame directly. More specifically, the phase of each frame can be modeled as a discrete classification problem, wherein each phase label may be represented as a one-hot vector, and an encoder may predict a probability distribution over phase classes for each frame.

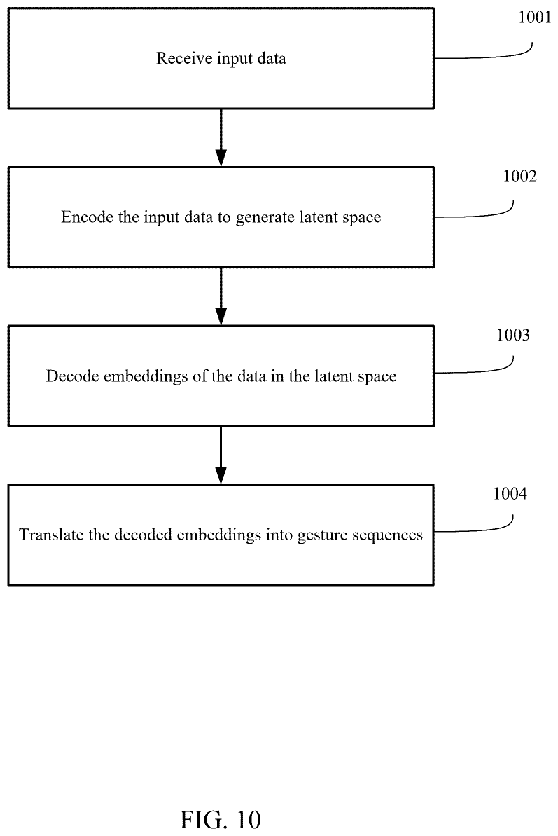

FIG. 10 is a flowchart illustrating a method, according to an embodiment.

Referring to FIG. 10, in step 1001, a neural network, e.g., a transformer-based CVAE, may receive input data including sequence labels and phase labels. The sequence labels may represent gestures and the phase labels include a phase label for each sequence frame within the gestures. For example, as illustrated in FIG. 3, gesture (or sequence) labels 310, 3D joints 311, pose parameters 312, and phase labels 313 are fed to or received by the transformer-based CVAE 302.

In step 1002, the neural network may encode the input data to create embeddings of the data that are represented in a latent space. For example, as illustrated in FIG. 3, the transformer encoder 325 may encode (process) the input sequences, i.e., the gesture labels 310, 3D joints 311, pose parameters 312, and phase labels 313, to create a continuous representation (or embeddings) of the input, which are represented in the latent space 330.

In step 1003, the neural network may decode the embeddings of the data that are represented in the latent space.

In step 1004, the neural network may translate the decoded embeddings into to gesture sequences corresponding to a specified gesture classification.

For example, as illustrated in FIG. 3, the decoding portion 305, which may be utilized to predict both joint poses and phase labels based on a single latent vector and an action label, may include the transformer decoder 340 that may use the embeddings in the latent space 330 to generate a sequence of vectors from which final poses are derived through linear projection at 341. More specifically, the transformer decoder 340 may generate diverse hand gesture sequences corresponding to the specified gesture classification.

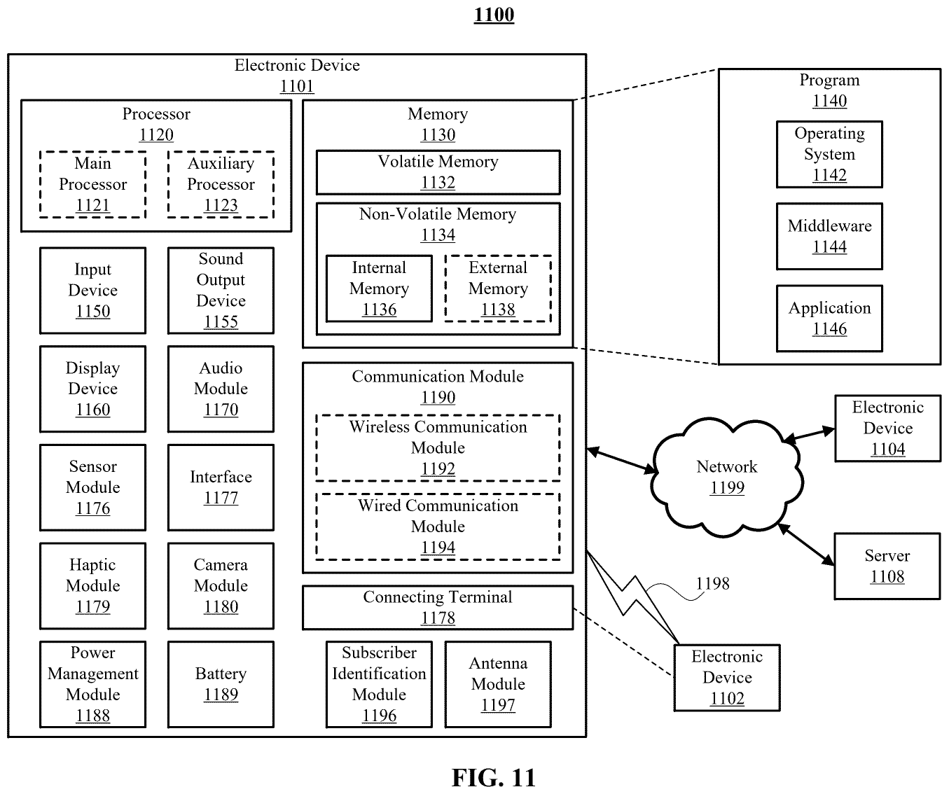

FIG. 11 is a block diagram of an electronic device in a network environment 1100, according to an embodiment.

Referring to FIG. 11, an electronic device 1101 in a network environment 1100 may communicate with an electronic device 1102 via a first network 1198 (e.g., a short-range wireless communication network), or an electronic device 1104 or a server 1108 via a second network 1199 (e.g., a long-range wireless communication network). The electronic device 1101 may communicate with the electronic device 1104 via the server 1108. The electronic device 1101 may include a processor 1120, a memory 1130, an input device 1150, a sound output device 1155, a display device 1160, an audio module 1170, a sensor module 1176, an interface 1177, a haptic module 1179, a camera module 1180, a power management module 1188, a battery 1189, a communication module 1190, a subscriber identification module (SIM) card 1196, or an antenna module 1197. In one embodiment, at least one (e.g., the display device 1160 or the camera module 1180) of the components may be omitted from the electronic device 1101, or one or more other components may be added to the electronic device 1101. Some of the components may be implemented as a single integrated circuit (IC). For example, the sensor module 1176 (e.g., a fingerprint sensor, an iris sensor, or an illuminance sensor) may be embedded in the display device 1160 (e.g., a display).

The processor 1120 may execute software (e.g., a program 1140) to control at least one other component (e.g., a hardware or a software component) of the electronic device 1101 coupled with the processor 1120 and may perform various data processing or computations. For example, the processor 1120 and may perform data processing or computations for transformer-based CVAE for multi-phased gesture synthesis as illustrated in FIG. 3.

As at least part of the data processing or computations, the processor 1120 may load a command or data received from another component (e.g., the sensor module 1176 or the communication module 1190) in volatile memory 1132, process the command or the data stored in the volatile memory 1132, and store resulting data in non-volatile memory 1134. The processor 1120 may include a main processor 1121 (e.g., a central processing unit (CPU) or an application processor (AP)), and an auxiliary processor 1123 (e.g., a graphics processing unit (GPU), an image signal processor (ISP), a sensor hub processor, or a communication processor (CP)) that is operable independently from, or in conjunction with, the main processor 1121. Additionally or alternatively, the auxiliary processor 1123 may be adapted to consume less power than the main processor 1121, or execute a particular function. The auxiliary processor 1123 may be implemented as being separate from, or a part of, the main processor 1121.

The auxiliary processor 1123 may control at least some of the functions or states related to at least one component (e.g., the display device 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). The auxiliary processor 1123 (e.g., an image signal processor or a communication processor) may be implemented as part of another component (e.g., the camera module 1180 or the communication module 1190) functionally related to the auxiliary processor 1123.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134. Non-volatile memory 1134 may include internal memory 1136 and/or external memory 1138.

The program 1140 may be stored in the memory 1130 as software, and may include, for example, an operating system (OS) 1142, middleware 1144, or an application 1146.

The input device 1150 may receive a command or data to be used by another component (e.g., the processor 1120) of the electronic device 1101, from the outside (e.g., a user) of the electronic device 1101. The input device 1150 may include, for example, a microphone, a mouse, or a keyboard.

The sound output device 1155 may output sound signals to the outside of the electronic device 1101. The sound output device 1155 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1160 may visually provide information to the outside (e.g., a user) of the electronic device 1101. The display device 1160 may include, for example, a display, a hologram device, or a projector and control circuitry to control a corresponding one of the display, hologram device, and projector. The display device 1160 may include touch circuitry adapted to detect a touch, or sensor circuitry (e.g., a pressure sensor) adapted to measure the intensity of force incurred by the touch. For example, the display device 1160 may visually display sequences generated using transformer-based CVAE for multi-phased gesture synthesis, e.g., as illustrated in FIG. 4.

The audio module 1170 may convert a sound into an electrical signal and vice versa. The audio module 1170 may obtain the sound via the input device 1150 or output the sound via the sound output device 1155 or a headphone of an external electronic device 1102 directly (e.g., wired) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. The sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device 1102 directly (e.g., wired) or wirelessly. The interface 1177 may include, for example, a high-definition multimedia interface (HDMI), a universal serial bus (USB) interface, a secure digital (SD) card interface, or an audio interface.

A connecting terminal 1178 may include a connector via which the electronic device 1101 may be physically connected with the external electronic device 1102. The connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or an electrical stimulus which may be recognized by a user via tactile sensation or kinesthetic sensation. The haptic module 1179 may include, for example, a motor, a piezoelectric element, or an electrical stimulator.

The camera module 1180 may capture a still image or moving images. The camera module 1180 may include one or more lenses, image sensors, image signal processors, or flashes. The power management module 1188 may manage power supplied to the electronic device 1101. The power management module 1188 may be implemented as at least part of, for example, a power management integrated circuit (PMIC).

The battery 1189 may supply power to at least one component of the electronic device 1101. The battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the AP) and supports a direct (e.g., wired) communication or a wireless communication. The communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as BLUETOOTH™, wireless-fidelity (Wi-Fi) direct, or a standard of the Infrared Data Association (IrDA)) or the second network 1199 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The antenna module 1197 may transmit or receive a signal or power to or from the outside (e.g., the external electronic device) of the electronic device 1101. The antenna module 1197 may include one or more antennas, and, therefrom, at least one antenna appropriate for a communication scheme used in the communication network, such as the first network 1198 or the second network 1199, may be selected, for example, by the communication module 1190 (e.g., the wireless communication module 1192). The signal or the power may then be transmitted or received between the communication module 1190 and the external electronic device via the selected at least one antenna.

Commands or data may be transmitted or received between the electronic device 1101 and the external electronic device 1104 via the server 1108 coupled with the second network 1199. Each of the electronic devices 1102 and 1104 may be a device of a same type as, or a different type, from the electronic device 1101. All or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1101. The electronic device 1101 may provide the outcome, with or without further processing of the outcome, as at least part of a reply to the request. To that end, a cloud computing, distributed computing, or client-server computing technology may be used, for example.

Overall, the present disclosure provides advancements in the synthesis of gesture-conditioned hand motion sequences, addressing critical gaps in current technologies and enhancing the realism and usability of synthesized hand gestures.

For example, some the advantages of the present disclosure may include enhanced temporal information with multi-phase annotations, biomechanical constraints, and/or improved training data for HPE and HGR.

According to the above-described embodiments, to provide enhanced temporal information with multi-phase annotations, sequence-level (gesture category) and frame-level annotations (multi-phase annotations) may be integrated for both static and dynamic gestures. For example, this may provide comprehensive, fine-grained annotations for gesture-related tasks, enhancing the realism and continuity of synthesized hand motions compared to technologies that do not consider such temporal variations.

According to the above-described embodiments, the incorporation of biomechanical constraints may improve anatomical realism for both outer and inner structures of the hand. For the outer surface, a method according to an embodiment of the disclosure may accurately model hand-part interactions (touching) for specific gestures, which is often overlooked in datasets relying solely on hand joint data, as well as efficiently prevent self-collision. For the inner structure, the anatomical constraints on joint angles may be used enforce adherence to human physical rules, which may improve the authenticity of generated gestures beyond typical methods.

According to the above-described embodiments, synthesized data can be used to train HPE and HGR systems more effectively, providing labeled sequences that closely mimic real-world hand gestures.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of generating gesture sequences, the method comprising:
receiving, by a neural network, input data including sequence labels and phase labels, where the sequence labels represent gestures and the phase labels include a phase label for each sequence frame within the gestures;
encoding, by the neural network, the input data to create embeddings of the data that are represented in a latent space;
decoding, by the neural network, the embeddings of the data that are represented in the latent space; and
translating the decoded embeddings into to gesture sequences corresponding to a specified gesture classification.

2. The method of claim 1, wherein the neural network includes a transformer-based conditional variational autoencoder (CVAE).

3. The method of claim 1, wherein the input data further includes pose parameters and 3-dimensional (3D) joint positions.

4. The method of claim 3, further comprising linearly embedding the phase labels, the pose parameters, and the 3D joint positions.

5. The method of claim 3, further comprising tokenizing the sequence labels, the phase labels, the pose parameters, and the 3D joint positions prior to the encoding.

6. The method of claim 1, further comprising performing reparameterization on a result of the encoding of the input data to create the embeddings of the data that are represented in the latent space.

7. The method of claim 1, performing sinusoidal positional encoding to the input data to capture temporal dependencies and spatial relationships within a gesture sequence.

8. The method of claim 1, wherein decoding the embeddings of the data that are represented in the latent space comprises introducing time information to the decoded embeddings through sinusoidal positional encodings.

9. The method of claim 1, wherein decoding the embeddings of the data that are represented in the latent space comprises deriving output pose parameters and output phase labels through linear projection.

10. The method of claim 9, further comprising translating the output pose parameters and the output phase labels into a synthesized gesture sequence.

11. The method of claim 1, further comprising applying a biomechanical constraint as a loss function during training of the neural network.

12. The method of claim 11, wherein the biomechanical constraint includes a motion angle limitation that limits joint angles.

13. The method of claim 11, wherein the biomechanical constraint includes an attraction loss between two fingers.

14. The method of claim 11, wherein the biomechanical constraint includes an anti-penetration loss for preventing self-collision of different parts of a hand.

15. The method of claim 1, further comprising applying a biomechanical projection layer that projects generated motion to an anatomically constrained motion.

16. The method of claim 15, wherein anatomically constrained motion includes at least one of intra-finger or inter-finger constraints.

17. The method of claim 1, further comprising applying a collision ratio-depth map that iteratively corrects self-penetration.

18. A system for generating gesture sequences, the system comprising:
a neural network;
a processor; and
a memory for storing instructions, which when executed by the processor, control the processor to:
control the neural network to receive input data including sequence labels and phase labels, where the sequence labels represent gestures and the phase labels include a phase label for each sequence frame within the gestures,
control the neural network to encode the input data to create embeddings of the data that are represented in a latent space,
control the neural network to decode the embeddings of the data that are represented in the latent space, and
translate the decoded embeddings into to gesture sequences corresponding to a specified gesture classification.

19. The system of claim 18, wherein the neural network includes a transformer-based conditional variational autoencoder (CVAE).

20. The system of claim 18, wherein the input data further includes pose parameters and 3-dimensional (3D) joint positions.
